(19) United States
(12) Patent Application Publication
(10) Pub. No.: US 2026/0002908 A1
(43) Pub. Date: Jan. 1, 2026

(54) SYSTEM FOR INSPECTING DISPLAY PANEL, METHOD OF INSPECTING DISPLAY PANEL AND ELECTRONIC DEVICE

(71) Applicant: SAMSUNG DISPLAY CO., LTD., YONGIN-SI, GYEONGGI-DO (KR)

(72) Inventors: Jae Hyung PARK, Yongin-si (KR); Jin Tea KIM, Yongin-si (KR); Sang Wook BAEK, Yongin-si (KR); Ki Soo CHUNG, Yongin-si (KR); Hee Dok CHOI, Yongin-si (KR)

(21) Appl. No.: 19/011,842

(22) Filed: Jan. 7, 2025

(30) Foreign Application Priority Data
Jul. 1, 2024 (KR) 10-2024-0086308

(51) Int. Cl. G01N 27/72; H04N 17/00

(52) U.S. Cl. CPC G01N 27/72; H04N 17/004

(57) ABSTRACT

A system for inspecting a display panel includes at least one carrier, at least one display panel respectively loaded on the at least one carrier, an inspection base including a plurality of inspection lines each extending in a first direction, wherein at least one of the plurality of inspection lines overlaps with a path through which the at least one carrier is configured to move, first coils overlapping with the plurality of inspection lines, second coils not overlapping with the plurality of inspection lines, and a plurality of inspection devices respectively overlapping with the plurality of inspection lines on a plane and configured to inspect the at least one display panel.

This application claims priority to Korean Patent Application No. 10-2024-0086308, filed on Jul. 1, 2024, and all the benefits accruing therefrom under 35 U.S.C. § 119, the content of which in its entirety is herein incorporated by reference.

### BACKGROUND

### 1. Technical Field

The present disclosure generally relates to a system for inspecting a display panel a method of inspecting a display panel and electronic device.

### 2. Related Art

A display device is a device which may visually display image data. A display panel may be used as a display for compact products such as, for example, mobile phones, and may be used as a display for large products such as, for example, televisions.

A display device may include a display panel in which a display element and a driving element are disposed. During a manufacturing process of the display device, an inspection process may be performed to determine whether the display panel normally operates. In some cases, a display panel determined to be normal through such an inspection process may be transferred to a next step of the manufacturing process of the display device.

The above information disclosed in this Related Art section is for enhancement of understanding of the background of the disclosure and therefore may contain information that does not form the prior art that is already known in this country to a person of ordinary skill in the art.

### SUMMARY

Embodiments provide a system for inspecting a display panel, in which the reliability of an inspection process of the display panel can be improved.

In accordance with an aspect of the present disclosure, there is provided a system for inspecting a display panel, including: at least one carrier; at least one display panel respectively loaded on the at least one carrier; an inspection base including a plurality of inspection lines each extending in a first direction, wherein at least one of the plurality of inspection lines overlaps with a path through which the at least one carrier is configured to move; first coils overlapping with the plurality of inspection lines; second coils not overlapping with the plurality of inspection lines; and a plurality of inspection devices respectively overlapping with the plurality of inspection lines on a plane, wherein the plurality of inspection devices are configured to inspect the at least one display panel.

The inspection system may further include a first inspection area, a second inspection area, and a third inspection area which overlap with the plurality of inspection lines, and the first inspection area, the second inspection area, and the third inspection area are sequentially disposed in the first direction on the inspection base. The first coils may include a (1_1)th coil, a (1_2)th coil, a (1_3)th coil, and a (1_4)th coil, which are disposed in a clockwise direction on the first inspection area.

The at least one carrier may include first carriers disposed on the first inspection area at a first time point. The first carriers may include a (1_1)th carrier disposed on the (1_1)th coil, a (1_2)th carrier disposed on the (1_2)th coil, a (1_3)th carrier disposed on the (1_3)th coil, and a (1_4)th carrier disposed on the (1_4)th coil.

The system may be configured to perform an inspection of the display panel disposed on the first carriers at the first time point. The system may be configured such that the first carriers do not move at the first time point.

The first coils may include a (1_5)th coil, a (1_6)th coil, a (1_7)th coil, and a (1_8)th coil, which are disposed on the second inspection area. The system may be configured to, after the first time point at which the inspection of the display panel disposed on the first carriers is completed, control the (1_1)th carrier such that the (1_1)th carrier is disposed on the (1_5)th coil, control the (1_2)th carrier such that the (1_2)th carrier is disposed on the (1_6)th coil, control the (1_3)th carrier such that the (1_3)th carrier is disposed on the (1_7)th coil, and control the (1_4)th carrier such that the (1_4)th carrier is disposed on the (1_8)th coil.

The at least one carrier may include second carriers disposed on the first coils after the first time point. The second carriers may include a (2_1)th carrier disposed on the (1_1)th coil, a (2_2)th carrier disposed on the (1_2)th coil, a (2_3)th carrier disposed on the (1_3)th coil, and a (2_4)th carrier disposed on the (1_4)th coil.

After the first time point, the first carriers and the second carriers may simultaneously move. For example, the system may be configured to, after the first time point, simultaneously move the first carriers and the second carriers.

The plurality of inspection devices may be configured to perform an inspection of display panels respectively disposed on the first carriers and the second carriers at a second time point after the first time point. The system may be configured to control the first carriers and the second carriers such that the first carriers and the second carriers do not move at the second time point.

The system may be configured to perform different respective inspections in the first inspection area, the second inspection area, and the third inspection area.

The inspection base may further include a controller controlling the first coils and the second coils in association with moving the at least one carrier.

The controller may be configured to control the first coils such that the at least one carrier moves in the first direction or in a direction opposite the first direction.

The controller may be configured to control the second coils such that the at least one carrier moves in a second direction intersecting the first direction or in a direction opposite the second direction.

Each of the first coils may have a major axis extending in the first direction, and each of the second coils may have a major axis extending in the second direction.

In accordance with another aspect of the present disclosure, there is provided a system for inspecting a display panel, the system including: at least one carrier; at least one display panel respectively loaded on the at least one carrier; an inspection base including a plurality of inspection lines each extending in a first direction, wherein at least one of the plurality of inspection lines overlaps with a path through which the at least one carrier is configured to move; main coils overlapping with the plurality of inspection lines, the main coils being disposed on the inspection base; a plurality of inspection devices respectively overlapping with the plurality of inspection lines on a plane, wherein the plurality of inspection devices are configured to inspect the at least one display panel in a state in which the at least one display panel is disposed on at least one of the plurality of inspection lines; a first sub-inspection base disposed at a front end of the inspection base and configured to introduce the at least one carrier onto the inspection base; and a second sub-inspection base configured to receive the at least one carrier from the inspection base after inspection of the at least one carrier is completed.

The inspection system may include: a first motor configured to move the first sub-inspection base in a second direction intersecting the first direction; and a second motor configured to move the second sub-inspection base in the second direction.

The inspection system may further include sub-coils respectively disposed on the first sub-inspection base and the second sub-inspection base. The main coils and the sub-coils may be configured to move the at least one carrier in the first direction.

In accordance with still another aspect of the present disclosure, there is provided a method of inspecting a display panel, the method including: moving, onto an inspection base, first carriers each having a display panel loaded thereon; moving, by coils disposed on the inspection base, the first carriers to a first inspection area; inspecting, by an inspection device, the display panels loaded on the first carriers; moving, onto the inspection base, second carriers each having a display panel loaded thereon; and moving, by the coils, the first carriers to a second inspection area and moving, by the coils, the second carriers to the first inspection area.

The method may further include inspecting the display panels loaded on the second carriers disposed in the first inspection area. The method may include simultaneously moving, by the coils, first carriers and the second carriers.

The moving of the first carriers and the second carriers may include moving, by the coils, the first carriers and the second carriers in a first direction and a second direction intersecting the first direction.

The inspection method may further include: moving the first carriers and the second carriers from a first sub-inspection base to the inspection base, wherein moving the first carriers and the second carriers to the inspection base includes moving the first sub-inspection base and the second sub-inspection base in a second direction intersecting the first direction; and moving the first carriers and the second carriers to a second sub-inspection base after the inspecting of the display panels loaded on the first carriers and the display panels loaded on the second carriers is completed, wherein moving the first carriers and the second carriers to the second sub-inspection base may include moving the second sub-inspection base in the second direction.

An electronic device, includes: a processor configured to provide input image data; a display device configured to display an image based on the input image data, the display device including a display panel inspected by the method of claim 20; and a power supply configured to supply power to the display device.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, the example embodiments are provided such that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a plan view illustrating coils of a system for inspecting a display panel in accordance with an embodiment of the present disclosure.

FIG. 2 is a plan view illustrating the inspection system illustrated in FIG. 1.

FIG. 3 is a side view illustrating the inspection system illustrated in FIG. 2, which is viewed in a first direction.

FIG. 4 is a side view illustrating the inspection system illustrated in FIG. 2, which is viewed in a second direction.

FIG. 5 is a flowchart illustrating a method of inspecting a display panel in accordance with an embodiment of the present disclosure.

FIGS. 6 to 10 are views sequentially illustrating the inspection method illustrated in FIG. 5.

FIGS. 11 to 14 are plan views illustrating a path through which a carrier can move in a first inspection area of the inspection system illustrated in FIG. 1.

FIGS. 15 to 17 are plan views illustrating a system for inspecting a display panel in accordance with another embodiment of the present disclosure.

### DETAILED DESCRIPTION

Hereinafter, embodiments of the present disclosure will be described in more detail with reference to the accompanying drawings. In the descriptions herein, parts supportive of understanding an operation according to the present disclosure are described, and the descriptions of other parts are omitted in order not to unnecessarily obscure subject matters of the present disclosure. In some aspects, the present disclosure is not limited to example embodiments described herein, but may be embodied in various different forms. Rather, example embodiments described herein are provided to thoroughly and completely describe the disclosed contents and to sufficiently transfer the ideas of the disclosure to a person of ordinary skill in the art.

In the entire specification, when an element is referred to as being “connected” or “coupled” to another element, it can be directly connected or coupled to the another element or be indirectly connected or coupled to the another element with one or more intervening elements interposed therebetween. The technical terms used herein are used for the purpose of illustrating a specific embodiment and not intended to limit the embodiment. It will be understood that when a component “includes” an element, unless there is another opposite description thereto, it should be understood that the component does not exclude another element but may further include another element. It will be understood that for the purposes of this disclosure, “at least one of X, Y, and Z” can be construed as X only, Y only, Z only, or any combination of two or more items X, Y, and Z (e.g., XYZ, XYY, YZ, ZZ). Similarly, for the purposes of this disclosure, “at least one selected from the group consisting of X, Y, and Z” can be construed as X only, Y only, Z only, or any combination of two or more items X, Y, and Z (e.g., XYZ, XYY, YZ, ZZ).

It will be understood that, although the terms “first”, “second,” and the like may be used herein to describe various elements, these elements should not be limited by these terms. These terms may be used to distinguish one element from another element. Thus, a “first” element discussed herein could also be termed a “second” element without departing from the teachings of the present disclosure.

Spatially relative terms, such as, for example, “below,” “above,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the example term, “above,” may encompass both an orientation of above and below. The apparatus may be otherwise oriented (e.g., rotated 90 degrees or at other orientations) and the spatially relative descriptors used herein interpreted accordingly.

In some aspects, the embodiments of the disclosure are described here with reference to schematic diagrams of example or ideal embodiments (and an intermediate structure) of the present disclosure, such that changes in a shape as illustrated due to, for example, manufacturing technology and/or a tolerance may be expected. Therefore, the embodiments of the present disclosure shall not be limited to the specific shapes of a region illustrated here, but include shape deviations caused by, for example, the manufacturing technology. The regions illustrated in the drawings are schematic in nature, and the shapes of the regions may or may not represent the actual shapes of the regions of the device, and do not limit the scope of the disclosure.

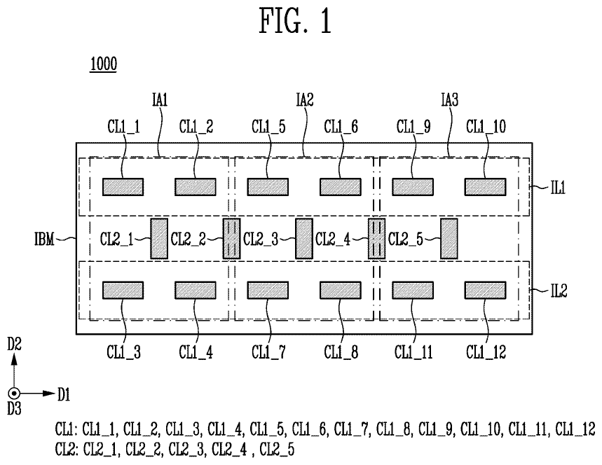

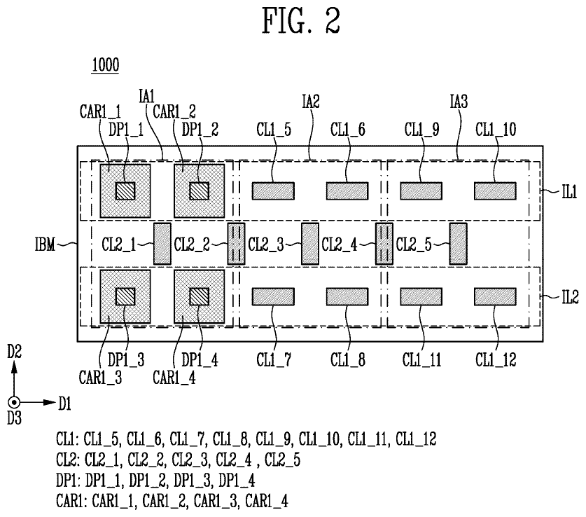

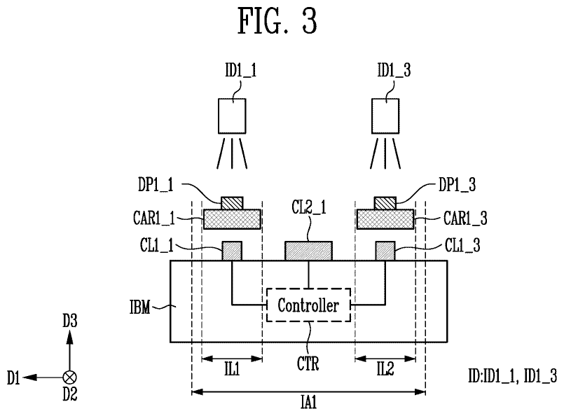

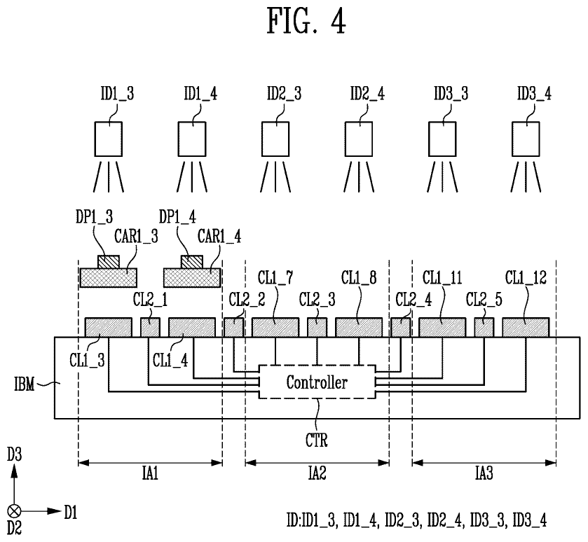

FIG. 1 is a plan view illustrating coils of a system for inspecting a display panel in accordance with an embodiment of the present disclosure. FIG. 2 is a plan view illustrating the inspection system illustrated in FIG. 1. FIG. 3 is a side view illustrating the inspection system illustrated in FIG. 2, which is viewed in a first direction. FIG. 4 is a side view illustrating the inspection system illustrated in FIG. 2, which is viewed in a second direction.

Referring to FIG. 1, the inspection system 1000 may include an inspection base IBM, first coils CL1, and second coils CL2. The inspection system 1000 may inspect whether a display panel is normally driven. For example, the inspection system 1000 may inspect whether a plurality of pixels included in the display panel emit light with a normal luminance (e.g., a target luminance), whether an electrical signal is normally transferred to a plurality of lines included in the display panel (e.g., whether transfer of the electrical signal satisfies some criteria), whether a touch sensing circuit normally operates (e.g., satisfies some performance criteria) when the display panel includes the touch sensing circuit, whether an electrical signal is normally transferred to pads connected to the plurality of lines (e.g., whether transfer of the electrical signal satisfies some criteria), and the like. However, embodiments of the present disclosure are not limited thereto.

The inspection base IBM may include a first inspection line IL1, a second inspection line IL2, a first inspection area IA1, a second inspection area IA2, and a third inspection area IA3.

The first inspection line IL1 and the second inspection line IL2 may extend in a first direction D1 on the inspection base IBM. The first inspection line IL1 and the second inspection line IL2 may be disposed such that the first inspection line IL1 and the second inspection line IL2 are spaced apart from each other. Each of the first inspection line IL1 and the second inspection line IL2 may be a path through which a carrier CAR may move.

The first to third inspection areas IA1 to IA3 may be sequentially disposed in the first direction D1. Each of the first to third inspection areas IA1 to IA3 may have a quadrangular shape. However, embodiments of the present disclosure are not limited thereto, and the first to third inspection areas IA1 to IA3 may be of any shape supportive of functions of the inspection system 1000 as described herein.

The first coils CL1 may be disposed in the first to third inspection areas IA1 to IA3. For example, the first coils CL1 may include a (1_1)th coil CL1_1, a (1_2)th coil CL1_2, a (1_3)th coil CL1_3, and a (1_4)th coil CL1_4, which are disposed in the first inspection area 1A1. The first coils CL1 may include a (1_5)th coil CL1_5, a (1_6)th coil CL1_6, a (1_7)th coil CL1_7, and a (1_8)th coil CL1_8, which are disposed in the second inspection area 1A2. The first coils CL1 may include a (1_9)th coil CL1_9, a (1_10)th coil CL1_10, a (1_11)th coil CL1_11, and a (1_12)th coil CL1_12, which are disposed in the third inspection area 1A3.

The (1_1)th coil CL1_1, the (1_2)th coil CL1_2, the (1_5)th coil CL1_5, the (1_6)th coil CL1_6, the (1_9)th coil CL1_9, and the (1_10)th coil CL1_10 may be disposed on the first inspection line IL1. In some aspects, the (1_3)th coil CL1_3, the (1_4)th coil CL1_4, the (1_7)th coil CL1_7, the (1_8)th coil CL1_8, the (1_11)th coil CL1_11, and the (1_12)th coil CL1_12 may be disposed on the second inspection line IL2.

The second coils CL2 may be disposed such that the second coils CL2 do not overlap with the first inspection line IL1 and the second inspection line IL2. For example, the second coils CL2 may be disposed between the first inspection line IL1 and the second inspection line IL2.

The second coils CL2 may include a (2_1)th coil CL2_1, a (2_2)th coil CL2_2, a (2_3)th coil CL2_3, a (2_4)th coil CL2_4, and a (2_5)th coil CL2_5. The second coils CL2 may move a carrier (e.g., a (1_1)th carrier CAR1_1) in a second direction D2 and a direction opposite the second direction D2.

Each of the first coils CL1 may have a major axis in the first direction D1 and a minor axis in the second direction D2. In some embodiments, each of the second coils CL2 may have a major axis in the second direction D2 and a minor axis in the first direction D1.

Referring to FIGS. 1 and 2 together, the inspection system 1000 may introduce carriers onto the inspection base IBM. For example, the (1_1)th carrier CAR1_1, a (1_2)th carrier CAR1_2, a (1_3)th carrier CAR1_3, and a (1_4)th carrier CAR1_4 may be introduced onto the inspection base IBM. The (1_1)th carrier CAR1_1 and the (1_2)th carrier CAR1_2 may be disposed on the first inspection line IL1. The (1_3)th carrier CAR1_3 and the (1_4)th carrier CAR1_4 may be disposed on the second inspection line IL2.

On a plane, the (1_1)th carrier CAR1_1 may be disposed such that the (1_1)th carrier CAR1_1 overlaps with the (1_1)th coil CL1_1. On a plane, the (1_2)th carrier CAR1_2 may be disposed such that the (1_2)th carrier CAR1_2 overlaps with the (1_2)th coil CL1_2. On a plane, the (1_3)th carrier CAR1_3 may be disposed such that the (1_3)th carrier CAR1_3 overlaps with the (1_3)th coil CL1_3. On a plane, the (1_4)th carrier CAR1_4 may be disposed such that the (1_4)th carrier CAR1_4 overlaps with the (1_4)th coil CL1_4.

Display panels may be loaded on carriers, respectively. For example, a (1_1)th display panel DP1_1 may be disposed on a top surface of the (1_1)th carrier CAR1_1. However, embodiments of the present disclosure are not limited to this illustrative example, and embodiments of the present disclosure support implementations including any carriers capable of moving display panels in accordance with the techniques described herein.

The first to third inspection areas IA1 to IA3 may be areas in which different respective inspections are performed. For example, the first to third inspection areas IA1 to IA3 may be areas in which the inspections described herein are performed, respectively.

Referring to FIGS. 3 and 4, the inspection system 1000 (see FIG. 1) may include a controller CTR and an inspection device ID.

The controller CTR may control the first coils CL1 and the second coils CL2. For example, FIG. 3 will be mainly described. The controller CTR may control a magnetic field (or respective magnetic fields) formed by the (1_1)th coil CL1_1, the (2_1)th coil CL2_1, and the (1_3)th coil CL1_3. Accordingly, the controller CRT may move the (1_1)th carrier CAR1_1 and the (1_3)th carrier CAR1_3, which are disposed adjacent to the (1_1)th coil CL1_1, the (2_1)th coil CL2_1, and the (1_3)th coil CL1_3. In other words, the (1_1)th carrier CAR1_1 and the (1_3)th carrier CAR1_3 may be moved by the magnetic field formed by the (1_1)th coil CL1_1, the (2_1)th coil CL2_1, and the (1_3)th coil CL1_3. In some embodiments, the controller CTR may be mounted on the inspection base IBM. However, embodiments of the present disclosure are not limited thereto.

On a plane, the inspection device ID may be disposed such that the inspection device ID overlaps with corresponding display panels. For example, a (1_1)th inspection device ID1_1 may be disposed such that the (1_1)th inspection device ID1_1 overlaps with the (1_1)th display panel DP1_1 in a third direction D3. In some aspects, a (1_3)th inspection device ID1_3 may be disposed such that the (1_3)th inspection device ID1_3 overlaps with a (1_3)th display panel DP1_3 in the third direction DR3.

Each inspection device ID may inspect corresponding display panels. In some aspects, each inspection device ID may inspect a corresponding display panel in a state in which the display panel is disposed on an inspection line. For example, the (1_1)th inspection device ID1_1 may inspect the (1_1)th display panel DP1_1. In some aspects, the (1_3)th inspection device ID1_3 may inspect the (1_3)th display panel DP1_3. In some embodiments, the inspection device ID may be an imaging device (e.g., a camera). Accordingly, the inspection device ID may inspect corresponding display panels by capturing or generating an image (e.g., a visual image, a thermal image, or the like) expressed by the corresponding display panels.

Referring to FIGS. 3 and 4, the (1_3)th carrier CAR1_3 and the (1_4)th carrier CAR1_4 may move in the first direction D1. The (1_3)th carrier CAR1_3 and the (1_4)th carrier CAR1_4 may undergo different inspections in the first and third inspection areas IA1 to IA3. For example, the controller CTR may control a plurality of coils CL in association with moving the (1_3)th carrier CAR1_3 and the (1_4)th carrier CAR1_4. Accordingly, display panels may undergo different inspections by inspection devices ID while the (1_3)th carrier CAR1_3 and the (1_4)th carrier CAR1_4 sequentially pass through the first inspection area IA1, the second inspection area IA2, and the third inspection area IA3.

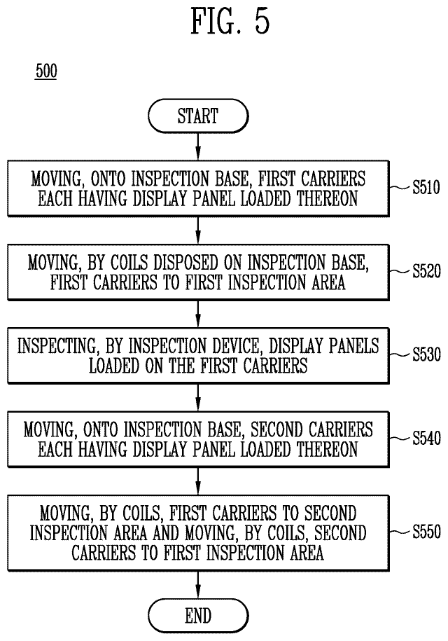

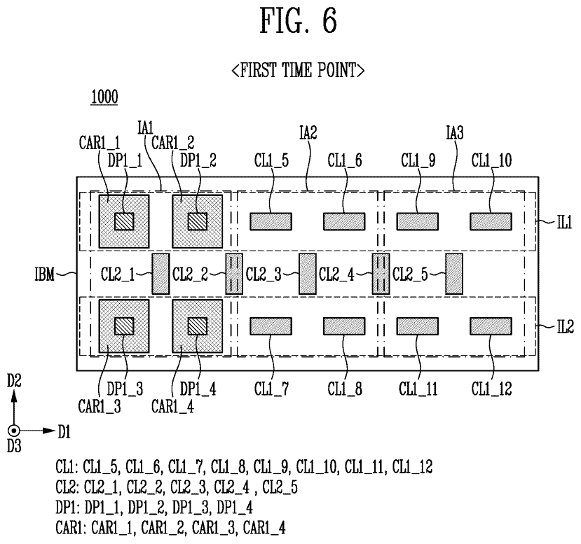

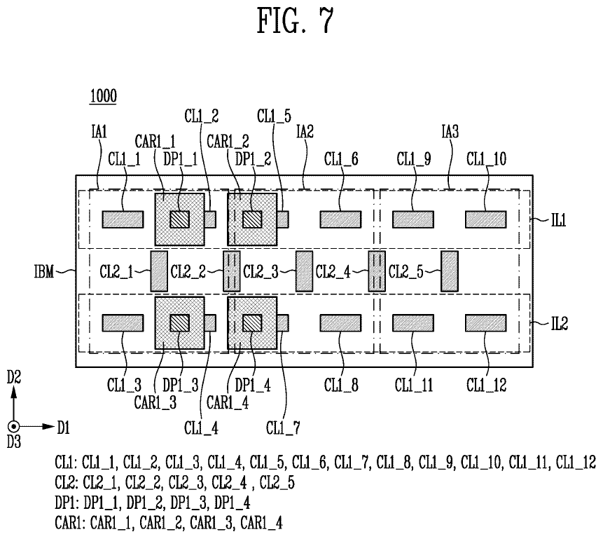

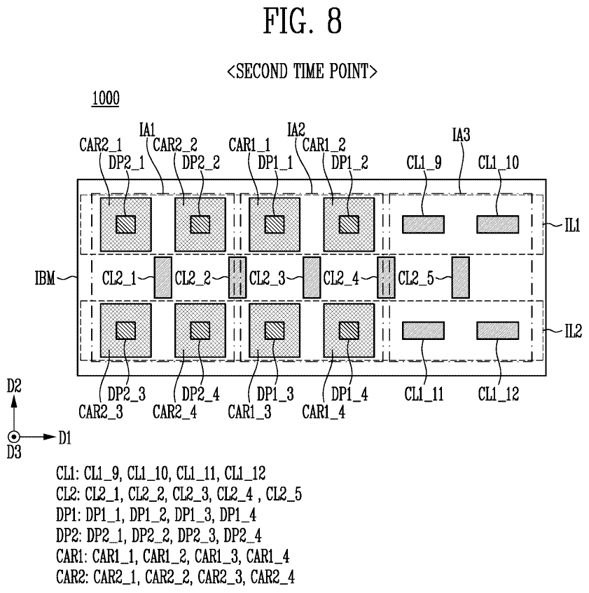

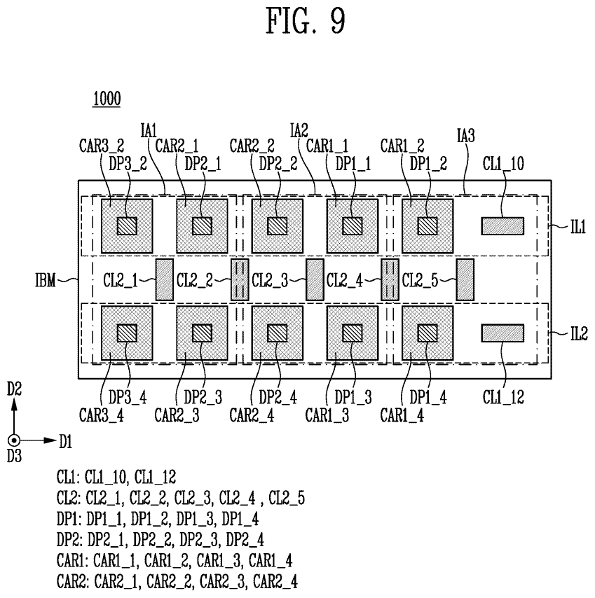

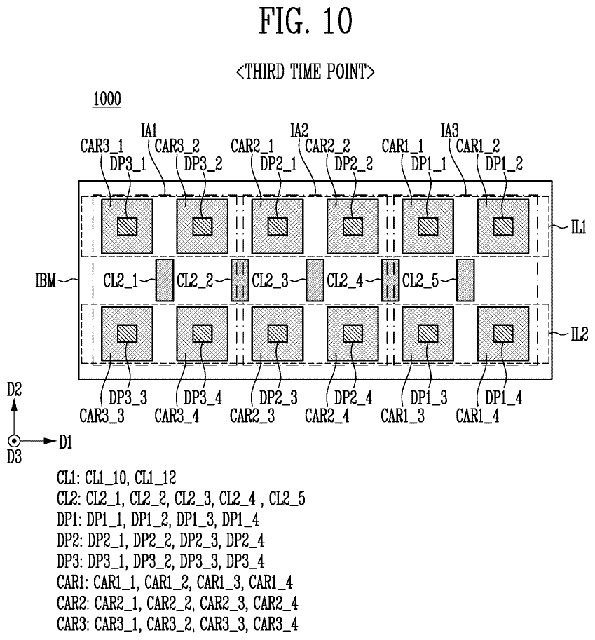

FIG. 5 is a flowchart illustrating a method 500 of inspecting a display panel in accordance with an embodiment of the present disclosure. FIGS. 6 to 10 are views sequentially illustrating the method 500 illustrated in FIG. 5.

In the descriptions of the method and processes herein, the operations may be performed in a different order than the order shown and/or described, or the operations may be performed in different orders or at different times. Certain operations may also be left out of the flowcharts, one or more operations may be repeated, or other operations may be added. Descriptions that an element “may be disposed,” “may be formed,” and the like include methods, processes, and techniques for disposing, forming, positioning, and modifying the element, and the like in accordance with example aspects described herein.

Referring to FIG. 5, the method 500 may include step S510 of moving, onto an inspection base, first carriers each having a display panel loaded thereon, step S520 of moving, by coils disposed on the inspection base, the first carriers to a first inspection area, step S530 of inspecting, by an inspection device, the display panels loaded on the first carriers, step S540 of moving, onto the inspection base, second carriers each having a display panel loaded thereon, and step S550 of moving, by the coils, the first carriers to a second inspection area and moving, by the coils, the second carriers to the first inspection area.

Referring to FIGS. 5 and 6, in the step S510 of moving, onto the inspection base, the first carriers each having the display panel loaded thereon, the inspection system 1000 may move, onto the inspection base IBM, first carriers CAR1 on which first display panels DP1 are loaded. In some examples, after the step S510, in the step S520 of moving, by the coils disposed on the inspection base, the first carriers to the first inspection area, the inspection system 1000 may move the first carriers CAR1 to the first inspection area IA1 through the first coils CL1 (see FIG. 1). The inspection system 1000 may move the first carriers CAR1 such that the first carriers CAR1 respectively correspond to the first coils CL1. For example, the inspection system 1000 may move the (1_1)th carrier CAR1_1, the (1_2)th carrier CAR1_2, the (1_3)th carrier CAR1_3, and the (1_4)th carrier CAR1_4 to respectively overlap with the (1_1)th coil CL1_1, the (1_2)th coil CL1_2, the (1_3)th coil CL1_3, and the (1_4)th coil CL1_4 on a plane.

In the step S530 of inspecting, by the inspection device, the display panels loaded on the first carriers, the inspection device ID (see FIG. 4) may inspect the first display panels DP1 loaded on the first carriers CAR1. For example, the inspection device ID may include a (1_2)th inspection device overlapping with the (1_2)th carrier CAR1_2 of the first inspection area IA1 on a plane. At a first time point, the (1_1)th inspection device ID1_1, the (1_2)th inspection device, the (1_3)th inspection device ID1_3, and the (1_4)th inspection device ID1_4 may inspect the (1_1)th display panel DP1_1, the (1_2)th display panel DP1_2, the (1_3)th display panel DP1_3, and the (1_4)th display panel DP1_4, respectively. At the first time point, the first carriers CAR1 may not move. That is, at the first time point, the controller CTR (see FIG. 4) may control the first coils CL1 such that the first carriers CAR1 do not move.

Referring to FIGS. 5 to 8, in the step S540 of moving, onto the inspection base, the second carriers each having the display panel loaded thereon, the inspection system 1000 may move second carriers CAR2 onto the inspection base IBM. In other words, the second carriers CAR2 may be introduced onto the inspection base IBM. In the step S540, the first carriers CAR1 may move in the first direction D1. In other words, the controller CTR may move the first carriers CAR1 in the first direction D1 through the first coils CL1.

Referring to FIGS. 5 to 8, in the step S550 of moving, by the coils, the first carriers to the second inspection area and moving, by the coils, the second carriers to the first inspection area, the first coils CL1 may move the first carriers CAR1 and the second carriers CAR2, which are disposed on the inspection base IBM, in the first direction D1. In other words, the controller CTR may control the first coils CL1 such that the first carriers CAR1 and the second carriers CAR2 move in the first direction D1. The first coils CL1 may move, to the second inspection area IA2, the first carriers CAR1 on which a first inspection is completed. In some aspects, the first coils CL1 may move, to the first inspection area IA1, the second carriers CAR2 newly introduced onto the inspection base IBM after the first time point. The first coils CL1 may simultaneously move the first carriers CAR1 and the second carriers CAR2. In other words, the inspection system 1000 may simultaneously mount the first carriers CAR1 and the second carriers CAR2 on the second inspection area IA2 and the first inspection area IA1, respectively. However, embodiments of the present disclosure are not limited thereto, and the present disclosure supports implementations of any carriers capable of moving display panels in accordance with the techniques described herein.

In some examples, after in the step S550, the inspection system 1000 may perform an inspection of each of the first display panels DP1 and second display panels DP2. In other words, the inspection system 1000 may perform the first inspection on the second display panels DP2 mounted on the first inspection area IA1 through the inspection device ID (see FIG. 4). In some aspects, the inspection system 1000 may perform a second inspection of the first display panels DP1 mounted on the second inspection area IA2 through the inspection device ID (see FIG. 4). That is, at a second time point, the inspection system 1000 may simultaneously perform inspections of the first display panels DP1 and the second display panels DP2. In some examples, the first carriers CAR1 and the second carriers CAR2 may not move. For example, the inspection system 1000 may control the first carriers CAR1 and the second carriers CAR2 such that the first carriers CAR1 and the second carriers CAR2 remain in a fixed position (e.g., do not move) at the second time point.

Referring to FIGS. 5 to 10, third carriers CAR3 may be introduced onto the inspection base IM after the second time point. For example, the inspection system 1000 may introduce a (3_1)th carrier CAR3_1, a (3_2)th carrier CAR3_2, a (3_3)th carrier CAR3_3, and a (3_4)th carrier CAR3_4 onto the inspection base IBM after the second time point. In some examples, after the third carriers CAR3 are introduced onto the inspection base IM, the controller CTR may move the first carriers CAR1, the second carriers CAR2, and the third carriers CAR3 in the first direction D1 through the first coils CL1. Accordingly, the first carriers CAR1, the second carriers CAR2, and the third carriers CAR3 may be mounted on the third inspection area IA3, the second inspection area IA2, and the first inspection area IA1, respectively.

At a third time point, the inspection system 1000 may perform different respective inspections on the display panels loaded on the carriers CAR in the first to third inspection areas IA1 to IA3. For example, the inspection system 1000 may perform a third inspection on the first display panels DP1 disposed on (loaded on) the third inspection area IA3. The inspection system 1000 may perform the second inspection on the second display panels DP2 disposed on (loaded on) the second inspection area IA2. The inspection system 1000 may perform the first inspection on third display panels DP3 disposed on (loaded on) the first inspection area IA1.

In accordance with embodiments of the present disclosure, as the inspections are simultaneously performed on the first to third display panels DP1 to DP3, the amount of time associated with inspecting the first to third display panels DP1 to DP3 (also referred to herein as inspection performance time) can be relatively shortened. In some aspects, the movement path of the first to third carriers CAR1 to CAR3 can be relatively shortened. For example, the inspection system 1000 may perform the inspections of the first to third display panels DP1 to DP3 without moving the first to third carriers CAR1 to CAR3 may not move to a separate space. That is, the inspections of the first to third display panels DP1 to DP3 can be performed on the movement path of the first to third carriers CAR1 to CAR3, and the amount of time (inspection performance time of) associated with inspecting the display panels can be relatively further shortened.

In some aspects, in accordance with embodiments of the present disclosure, the reliability of the inspections of the first to third display panels DP1 to DP3 can be improved. Embodiments of the present disclosure may include maintaining the first to third carriers CAR1 to CAR3 in a fixed position (e.g., such that the first to third carriers CAR1 to CAR3 do not move) at the first time point, the second time point, and the third time point, at which an inspection of at least one of the first to third display panels DP1 to DP3 is performed. Accordingly, when the inspections of the first to third display panels DP1 to DP3 are performed, a risk of the reliability of inspections deteriorating due to vibrations generated in association with movement of the first to third carriers CAR1 can be prevented.

Examples described herein with respect to a time point (e.g., first time point, second time point, and the like) are not necessarily limited to a time point. For example, embodiments of the present disclosure described herein with respect to a time point may be similarly implemented during a given time period (e.g., a first temporal duration, a second temporal duration, and the like) or at a given set of time points (e.g., a first set of time points, a second set of time points, and the like).

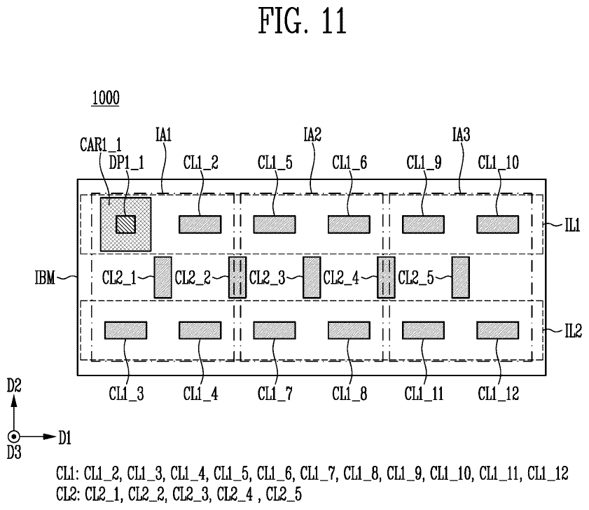

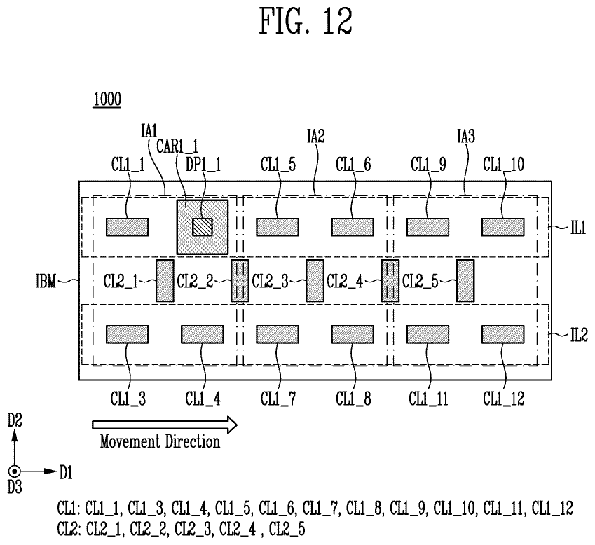

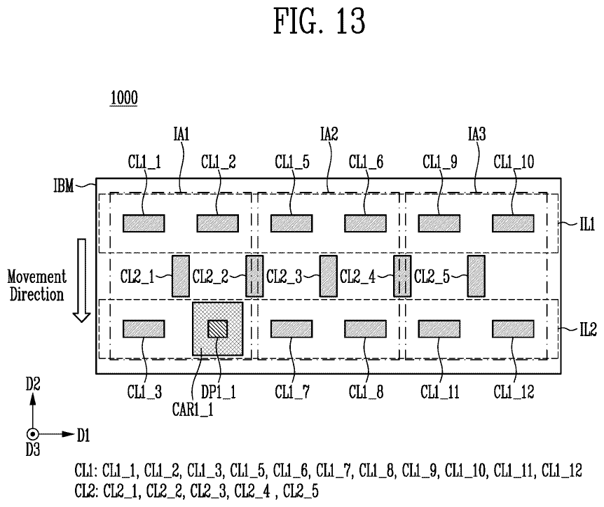

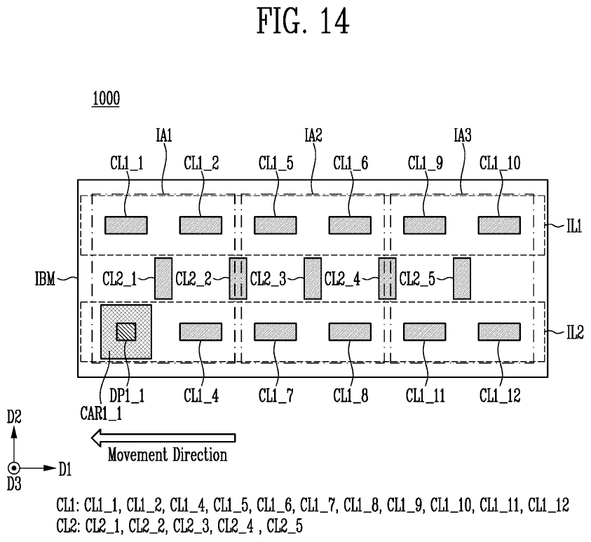

FIGS. 11 to 14 are plan views illustrating a path through which a carrier can move in the first inspection area of the inspection system illustrated in FIG. 1.

In FIGS. 11 to 14, an example path through which the inspection system 1000 in accordance with embodiments of the present disclosure can move the (1_1)th carrier CAR1_1 in the first inspection area IA1 is illustrated. The second inspection area IA2 and the third inspection area IA3 may include aspects of the first inspection area IA1 and be described identically to the first inspection area IA1. Hereinafter, overlapping descriptions will be omitted.

Referring to FIGS. 11 and 12, the inspection system 1000 may move the (1_1)th carrier CAR1_1 in the first direction D1. For example, the controller CTR (see FIG. 4) may control the first coils CL1 such that the (1_1)th carrier CAR1_1 moves in the first direction D1.

Referring to FIGS. 12 and 13, the inspection system 1000 may move the (1_1)th carrier CAR1_1 in the direction opposite the second direction D2. In some aspects, the inspection system 1000 may move the (1_1)th carrier CAR1_1 in the second direction D2. For example, the controller CTR may control the second coils CL2 such that the (1_1)th carrier CAR1_1 moves in the second direction D2 and/or the direction opposite the second direction D2.

In accordance with embodiments of the present disclosure, the inspection system 1000 can freely move the (1_1)th carrier CAR1_1 on the inspection base through the first coils CL1 and the second coils CL2. For example, the first coils CL1 may move the (1_1)th carrier CAR1_1 in the first direction D1 and a direction opposite the first direction D1 on the inspection base IBM. In some aspects, the second coils CL2 may move the (1_1)th carrier CAR1_1 in the second direction D2 and a direction opposite the second direction D2 on the inspection base IBM. Accordingly, the stability of an inspection process of a display panel can be improved. For example, a risk that a carrier (e.g., the (1_1)th carrier CAR1_1) disposed on the first inspection line IL1 will not move while the inspection process is performed can be prevented.

In accordance with a comparative example, other inspection systems may not be capable of performing the inspection process In contrast, for example, in accordance with embodiments of the present disclosure and the inspection system 1000, the (1_1)th carrier CAR1_1 may be moved in the first direction D1 and/or the second direction D2, such that the entire inspection process can be continuously performed.

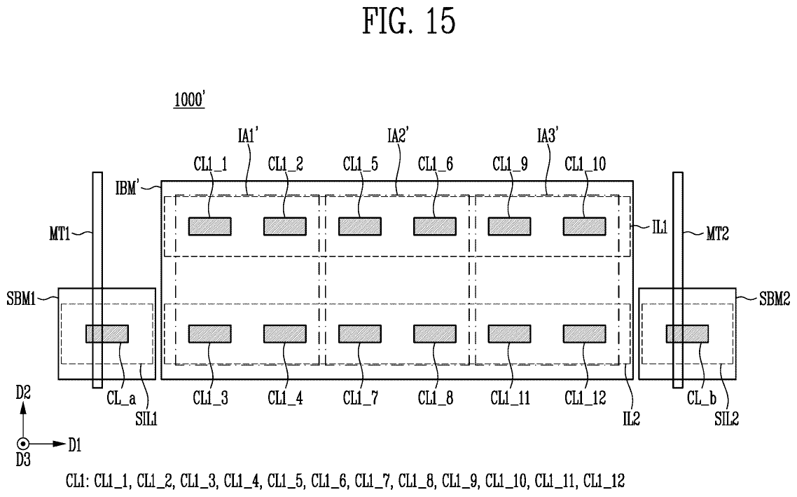

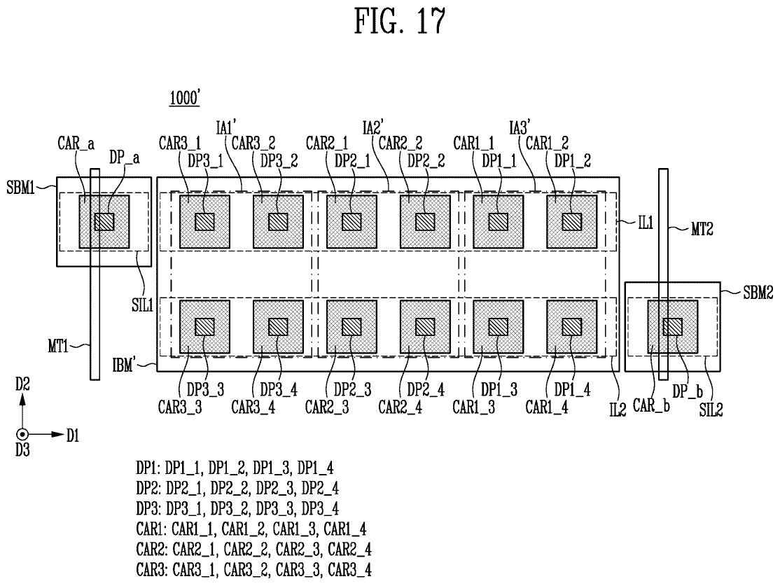

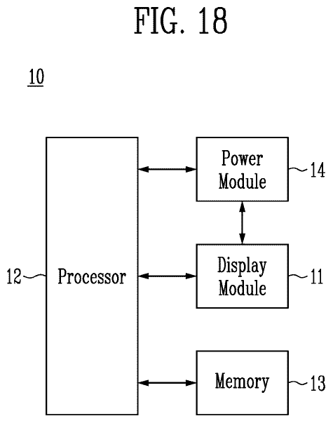

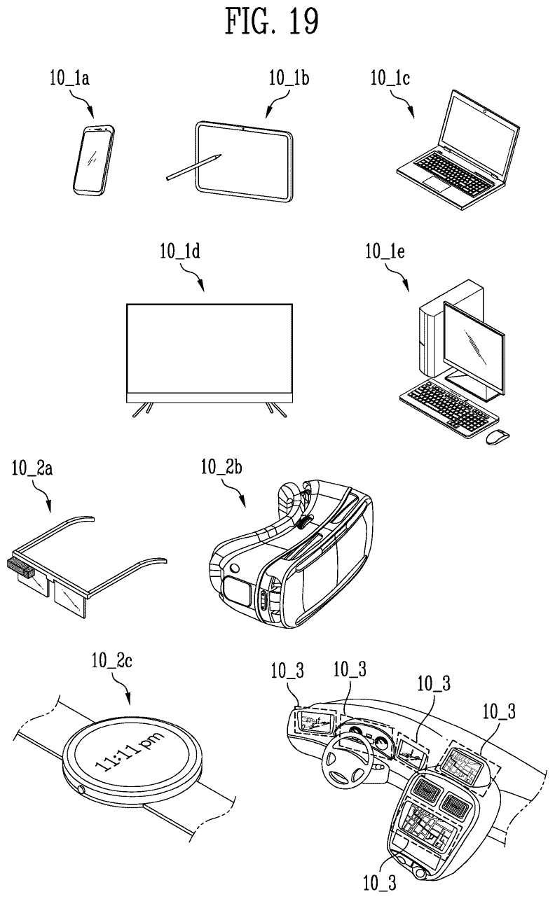

FIGS. 15 to 17 are plan views illustrating a system for inspecting a display panel in accordance with another embodiment of the present disclosure.

Referring to FIGS. 15 to 17, the inspection system 1000′ may include an inspection base IBM′, a first motor MT1, a second motor MT2, a first sub-inspection base SBM1, and a second sub-inspection base SBM2.

The inspection base IBM′ may include a first inspection line IL1, a second inspection line IL2, and first to third inspection areas IA1′ to IA3′. Each of the first to third inspection areas inspection areas IA1′ to IA3′ may include four first coils CL1. For example, the first inspection area IA1′ may include a (1_1)th coil CL1_1, a (1_2)th coil CL1_2, a (1_3)th coil CL1_3, and a (1_4)th coil CL1_4. First coils CL1, the first inspection line IL1, and the second inspection line IL2, which are illustrated in FIGS. 15 to 17, may include aspects of and be described identically to the first coils CL1, the first inspection line IL1, and the second inspection line IL2. Hereinafter, overlapping descriptions will be omitted.

The first sub-inspection base SBM1 may be disposed at a front end of the inspection base IBM′. The first sub-inspection base SBM1 may introduce the at least on carrier CAR onto the inspection base IBM′.

The first sub-inspection base SBM1 may include a first sub-inspection line SIL1 and a first sub-coil CL_a. The second sub-inspection base SBM2 may include a second sub-inspection line SIL2 and a second sub-coil CL_b.

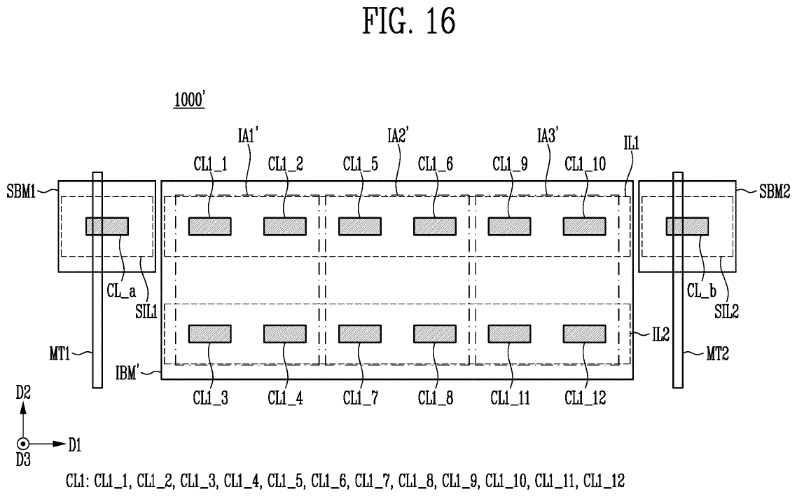

Referring to FIGS. 15 and 16, the first motor MT1 may move the first sub-inspection base SBM1 in the second direction D2 and/or the direction opposite the second direction D2. The second motor MT2 may move the second sub-inspection base SBM2 in the second direction D2 and/or the direction opposite the second direction D2.

The first sub-inspection line SIL1 and the second sub-inspection line SIL2 may extend in the first direction D1. The first sub-inspection line SIL1 and the second sub-inspection line SIL2 may correspond to the first inspection line IL1 and/or the second inspection line IL2. For example, referring to FIG. 15, the first sub-inspection line SIL1 may correspond to the second inspection line IL2. In some aspects, referring to FIG. 16, the first sub-inspection line SIL1 may correspond to the first inspection line IL1.

The inspection system 1000′ may perform an inspection of a display panel without implementing (i.e., without disposing) the second coils CL2 (see FIG. 1) disposed on the inspection base IBM′. For example, the first sub-inspection base SBM1 and the second sub-inspection base SBM2 of the inspection system 1000′ may introduce carriers onto the inspection base IBM′ and/or remove carriers from the inspection base IBM′ while the first sub-inspection base SBM1 and the second sub-inspection base SBM2 moved in the second direction D2. For example, the inspection system 1000′ may introduce carriers onto the inspection base IBM′ or remove carriers from the inspection base IBM′ by moving the first sub-inspection base SBM1 or the second sub-inspection base SBM2 in the second direction D2. Accordingly, the movement of the carriers in the second direction D2 on the inspection base IBM′ may not be unnecessary. In accordance with embodiments of the present disclosure, the inspection system 1000′ may be implemented with a relatively small number of coils, and manufacturing cost of the inspection system 1000′ can be relatively reduced.

FIG. 18 is a block diagram of an electronic device according to an embodiment. FIG. 19 shows schematic views of various embodiments of an electronic device.

A display panel (or a display device) according to an embodiment is applicable to various types of electronic devices. For example, the display panel inspected by the inspection system 1000, 1000′ (see FIGS. 1, 15) is applicable to various types of electronic devices. In an embodiment, an electronic device includes the above-described display panel (or a display device) and may further include other modules or devices having additional functions in addition to the display device.

Referring to FIG. 18, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data and/or information used to operate the processor 12 or the display module 11. When the processor 12 executes an application stored in the memory 13, image data signals and/or input control signals may be transferred to the display module 11. The display module 11 may process the provided signals and output image information on a display screen.

The power module 14 may include a power supply module, such as a power adapter or a battery device, and a power conversion module. The power conversion module converts power supplied by the power supply module and generates power to operate the electronic device 10.

At least one of the above-described components of the electronic device 10 may be included in the display panel (or a display device) according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10.

Referring to FIG. 19, various types of electronic devices to which embodiments of a display device are applied may include an electronic device to display images such as a smartphone 10_1a, a tablet PC 10_1b, a laptop computer 10_1c, a television (TV) 10_1d, and a desktop monitor 10_1e, a wearable electronic device including a display module such as smart glasses 10_2a, a head-mounted display (HMD) 10_2b, and a smart watch 10_2c, and an automotive electronic device 10_3 including a display module such as a center information display (CID) disposed at the instrument cluster, the center fascia, and the dashboard of a vehicle, and a room mirror display.

In accordance with the present disclosure, a system for inspecting a display panel is provided which supports improved reliability of an inspection process of the display panel.

Example embodiments have been disclosed herein, and although specific terms are employed, they are used and are to be interpreted in a generic and descriptive sense and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A system for inspecting a display panel, the system comprising:
at least one carrier;
at least one display panel respectively loaded on the at least one carrier;
an inspection base comprising a plurality of inspection lines each extending in a first direction, wherein at least one of the plurality of inspection lines overlaps with a path through which the at least one carrier is configured to move;
first coils overlapping with the plurality of inspection lines;
second coils not overlapping with the plurality of inspection lines; and
a plurality of inspection devices respectively overlapping with the plurality of inspection lines on a plane, wherein the plurality of inspection devices are configured to inspect the at least one display panel.

2. The system of claim 1, further comprising:
a first inspection area, a second inspection area, and a third inspection area which overlap with the plurality of inspection lines,
wherein:
the first inspection area, the second inspection area, and the third inspection area are sequentially disposed in the first direction on the inspection base, and
the first coils comprise a (1_1)th coil, a (1_2)th coil, a (1_3)th coil, and a (1_4)th coil which are disposed in a clockwise direction on the first inspection area.

3. The system of claim 2, wherein:
the at least one carrier comprises first carriers disposed on the first inspection area at a first time point, and
the first carriers comprise a (1_1)th carrier disposed on the (1_1)th coil, a (1_2)th carrier disposed on the (1_2)th coil, a (1_3)th carrier disposed on the (1_3)th coil, and a (1_4)th carrier disposed on the (1_4)th coil.

4. The system of claim 3, wherein the system is configured to:
perform an inspection of the display panel disposed on the first carriers at the first time point, and
control the first carriers such that the first carriers do not move at the first time point.

5. The system of claim 4, wherein:
the first coils comprise a (1_5)th coil, a (1_6)th coil, a (1_7)th coil, and a (1_8)th coil which are disposed on the second inspection area, and
the system is configured to, after the first time point at which the inspection of the display panel disposed on the first carriers is completed, control the (1_1)th carrier such that the (1_1)th carrier is disposed on the (1_5)th coil, control the (1_2)th carrier such that the (1_2)th carrier is disposed on the (1_6)th coil, control the (1_3)th carrier such that the (1_3)th carrier is disposed on the (1_7)th coil, and control the (1_4)th carrier such that the (1_4)th carrier is disposed on the (1_8)th coil.

6. The system of claim 5, wherein:
the at least one carrier comprises second carriers disposed on the first coils after the first time point, and
the second carriers comprise a (2_1)th carrier disposed on the (1_1)th coil, a (2_2)th carrier disposed on the (1_2)th coil, a (2_3)th carrier disposed on the (1_3)th coil, and a (2_4)th carrier disposed on the (1_4)th coil.

7. The system of claim 6, wherein the system is configured to, after the first time point, simultaneously move the first carriers and the second carriers.

8. The system of claim 6, wherein:
the plurality of inspection devices are configured to perform an inspection of display panels respectively disposed on the first carriers and the second carriers at a second time point after the first time point, and
the system is configured to control the first carriers and the second carriers such that the first carriers and the second carriers do not move at the second time point.

9. The system of claim 2, wherein the system is configured to perform different respective inspections in the first inspection area, the second inspection area, and the third inspection area.

10. The system of claim 1, wherein the inspection base further comprises a controller controlling the first coils and the second coils in association with moving the at least one carrier.

11. The system of claim 10, wherein the controller is configured to control the first coils such that the at least one carrier moves in the first direction or in a direction opposite the first direction.

12. The system of claim 11, wherein the controller is configured to control the second coils such that the at least one carrier moves in a second direction intersecting the first direction or in a direction opposite the second direction.

13. The system of claim 12, wherein:
each of the first coils has a major axis extending in the first direction, and
each of the second coils has a major axis extending in the second direction.

14. A system for inspecting a display panel, the system comprising:
at least one carrier;
at least one display panel respectively loaded on the at least one carrier;
an inspection base comprising a plurality of inspection lines each extending in a first direction, wherein at least one of the plurality of inspection lines overlaps with a path through which the at least one carrier is configured to move;
main coils overlapping with the plurality of inspection lines, the main coils being disposed on the inspection base;
a plurality of inspection devices respectively overlapping with the plurality of inspection lines on a plane, wherein the plurality of inspection devices are configured to inspect the at least one display panel in a state in which the at least one display panel is disposed on at least one of the plurality of inspection lines;
a first sub-inspection base disposed at a front end of the inspection base and configured to introduce the at least one carrier onto the inspection base; and
a second sub-inspection base configured to receive the at least one carrier from the inspection base after inspection of the at least one carrier is completed.

15. The system of claim 14, further comprising:
a first motor configured to move the first sub-inspection base in a second direction intersecting the first direction; and
a second motor configured to move the second sub-inspection base in the second direction.

16. The system of claim 15, further comprising:
sub-coils respectively disposed on the first sub-inspection base and the second sub-inspection base,
wherein the main coils and the sub-coils are configured to move the at least one carrier in the first direction.

17. A method of inspecting a display panel, the method comprising:
moving, onto an inspection base, first carriers each having a display panel loaded thereon;
moving, by coils disposed on the inspection base, the first carriers to a first inspection area;
inspecting, by an inspection device, the display panels loaded on the first carriers;
moving, onto the inspection base, second carriers each having a display panel loaded thereon; and
moving, by the coils, the first carriers to a second inspection area and moving, by the coils, the second carriers to the first inspection area.

18. The method of claim 17, further comprising:
inspecting the display panels loaded on the second carriers disposed in the first inspection area,
wherein the method comprises simultaneously moving, by the coils, the first carriers and the second carriers.

19. The method of claim 18, wherein the moving of the first carriers and the second carriers comprises moving, by the coils, the first carriers and the second carriers in a first direction and a second direction intersecting the first direction.

20. The inspection method of claim 17, further comprising:
moving the first carriers and the second carriers from a first sub-inspection base to the inspection base; and
moving the first carriers and the second carriers to a second sub-inspection base after an inspection is completed,
wherein the first sub-inspection base and the second sub-inspection base move in a second direction.

21. An electronic device, comprising:
a processor configured to provide input image data;
a display device configured to display an image based on the input image data, the display device including a display panel inspected by the method of claim 17; and
a power supply configured to supply power to the display device.
